(19) United States
(12) Patent Application Publication
(10) Pub. No.: US 2024/0421337 A1
(43) Pub. Date: Dec. 19, 2024

(54) FUEL CELL

(71) Applicants: HYUNDAI MOTOR COMPANY, Seoul (KR); KIA CORPORATION, Seoul (KR)

(72) Inventors: Jae Min Ahn, Yongin-si (KR); Yong Suk Heo, Seoul (KR)

(73) Assignees: HYUNDAI MOTOR COMPANY, Seoul (KR); KIA CORPORATION, Seoul (KR)

(21) Appl. No.: 18/523,241

(22) Filed: Nov. 29, 2023

(30) Foreign Application Priority Data
Jun. 15, 2023 (KR) 10-2023-0076677

(51) Int. Cl. H01M 8/248; H01M 8/2475

(52) U.S. Cl. CPC H01M 8/248; H01M 8/2475; H01M 2008/1095

(57) ABSTRACT

A fuel cell includes a cell stack including a plurality of unit cells stacked in a first direction, first and second end plates disposed on respective end portions of the cell stack, and a plurality of clamping members clamping the unit cells in the first direction thereof. The clamping members include a first clamping member disposed on an edge portion of the cell stack to extend in the first direction and a second clamping member disposed on at least one of the upper surface or the lower surface of the cell stack to extend in the first direction thereof. The first clamping member includes a first portion disposed on or under the cell stack at a position adjacent to the edge portion and a second portion bent from the first portion and disposed on a side portion of the cell stack.

### CROSS-REFERENCE TO RELATED APPLICATION

The present application claims priority to Korean Patent Application No. 10-2023-0076677, filed on Jun. 15, 2023, the entire contents of which is incorporated herein for all purposes by this reference.

### BA BACKGROUND OF THE PRESENT DISCLOSURE

### Field of the Present Disclosure

The present disclosure relates to a fuel cell.

### Description of Related art

A fuel cell may generate electric power through an oxidation reaction of hydrogen as a reactant gas and a reduction reaction of oxygen as a reactant gas using a polymer electrolyte membrane. To the present end, a unit cell included in a fuel cell may include a separator, a gas diffusion layer (GDL), and a membrane electrode assembly (MEA). Hundreds of unit cells may be stacked to obtain desired output.

One of the most important factors in manufacturing a fuel cell is to assure stability in the event of collision. If current leaks from a cell stack included in a fuel cell to a high-voltage power generation system due to collision, there is a risk of a high-voltage electrocution accident. A fuel cell may include a housing or an operating device to protect a plurality of unit cells.

A vehicle provided with a fuel cell may be exposed to various collision accidents. Low-speed collision accidents, in which there is no need to interrupt supply of power, frequently occur. If a cell stack, in which hundreds of cells are stacked in a longitudinal direction, receives impact in a lateral direction due to collision or the like, slip may occur, resulting in cell misalignment or short circuit. Therefore, various research with the goal of solving the present problem is underway.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell that substantially obviates one or more problems due to limitations and disadvantages of the related art.

Embodiments provide a fuel cell which is resistant to external impact and is reduced in size.

However, objects to be accomplished by the exemplary embodiments are not limited to the above-mentioned objects, and other objects not mentioned herein will be clearly understood by those skilled in the art from the following description.

A fuel cell according to various exemplary embodiments of the present disclosure may include a cell stack including a plurality of unit cells stacked in a first direction, first and second end plates disposed on respective end portions of the cell stack, and a plurality of clamping members configured to clamp the plurality of unit cells in the first direction and spaced from each other in a second direction intersecting the first direction. The plurality of clamping members may include a first clamping member disposed on an edge portion of the cell stack to extend in the first direction and a second clamping member disposed on at least one of an upper portion or a lower portion of the cell stack to extend in the first direction. The first clamping member may include a first portion disposed on or under the cell stack at a position adjacent to the edge portion and a second portion bent from the first portion to be disposed on a side portion of the cell stack. The first portion may include a first metal portion and a first insulating portion disposed between the first metal portion and the cell stack, and the second portion may include a second insulating portion disposed on the side portion of the cell stack.

In an exemplary embodiment of the present disclosure, the first insulating portion and the second insulating portion may be integrally formed with each other.

In an exemplary embodiment of the present disclosure, the second clamping member may include a second metal portion and a third insulating portion disposed between the second metal portion and the cell stack.

In an exemplary embodiment of the present disclosure, the second portion may cover an entire area of the side portion of the cell stack.

In an exemplary embodiment of the present disclosure, the second portion may include an impact mitigation pattern.

In an exemplary embodiment of the present disclosure, the second portion may cover a part of the side portion of the cell stack.

In an exemplary embodiment of the present disclosure, the second portion may be formed so that the thickness thereof in the second direction is gradually reduced in a direction away from the first portion.

In an exemplary embodiment of the present disclosure, the cell stack may include an upper surface, a low surface opposite to the upper surface in a third direction intersecting each of the first direction and the second direction, a first side surface located between the upper surface and the lower surface, and a second side surface opposite to the first side surface in the second direction. The plurality of clamping members may include a first clamping bar disposed on a boundary at which the upper surface and the first side surface are contiguous with each other, a second clamping bar disposed on a boundary at which the upper surface and the second side surface are contiguous with each other, a third clamping bar disposed on a boundary at which the lower surface and the first side surface are contiguous with each other, a fourth clamping bar disposed on a boundary at which the lower surface and the second side surface are contiguous with each other, a fifth clamping bar disposed on the upper surface, and a sixth clamping bar disposed on the lower surface.

In an exemplary embodiment of the present disclosure, each of the first, second, third and fourth clamping bars may correspond to the first clamping member, and each of the fifth and sixth clamping bars may correspond to the second clamping member.

In an exemplary embodiment of the present disclosure, each of the first and fourth clamping bars may correspond to the first clamping member, and each of the second, third, fifth, and sixth clamping bars may correspond to the second clamping member.

In an exemplary embodiment of the present disclosure, each of the second and third clamping bars may correspond to the first clamping member, and each of the first, fourth, fifth and sixth clamping bars may correspond to the second clamping member.

In an exemplary embodiment of the present disclosure, the second insulating portion may include an elastic modulus of 12 GPa at 23° C., impact strength of 10 KJ/m² or greater, and a length of 2 mm to 3 mm in the third direction. One end portion of the second insulating portion, which abuts the first metal portion, may include a thickness of 15 mm or greater in the second direction, and the opposite end portion of the second insulating portion may include a thickness of 4 mm or greater in the second direction.

In an exemplary embodiment of the present disclosure, the second insulating portion of the first clamping bar and the second insulating portion of the third clamping bar may be spaced from each other in the third direction, and the second insulating portion of the second clamping bar and the second insulating portion of the fourth clamping bar may be spaced from each other in the third direction.

In an exemplary embodiment of the present disclosure, the second insulating portion of the first clamping bar and the second insulating portion of the third clamping bar may be integrally formed with each other, and the second insulating portion of the second clamping bar and the second insulating portion of the fourth clamping bar may be integrally formed with each other.

In an exemplary embodiment of the present disclosure, the fuel cell may further include a side cover coupled to the second end plate and an enclosure coupled to the first end plate and the side cover to enclose a side portion of the cell stack.

In an exemplary embodiment of the present disclosure, the fuel cell may further include a first coupling portion configured to couple the first end plate to one end portion of each of the clamping members, a second coupling portion configured to couple the second end plate to the other end portion of each of the clamping members, and a third coupling portion configured to couple the side cover to the second end plate.

In an exemplary embodiment of the present disclosure, at least one of the first, second, and third coupling portions may include a flange bolt and a sealing washer disposed between the flange bolt and an insertion hole formed to allow the flange bolt to pass therethrough or to be inserted thereinto.

In an exemplary embodiment of the present disclosure, the insertion hole may have a diameter of 5 mm or greater than 5 mm and a depth of 9 mm or greater than 9 mm.

A fuel cell according to another exemplary embodiment of the present disclosure may include a cell stack including a plurality of unit cells stacked in a first direction, first and second end plates disposed on a first end portion and a second end portion of the cell stack, respectively, a side cover coupled to the second end plate, an enclosure coupled to the first end plate and the side cover to enclose a side portion of the cell stack, a first clamping member configured to clamp the plurality of unit cells in the first direction and disposed on an edge portion of the cell stack to extend in the first direction, a second clamping member configured to clamp the plurality of unit cells in the first direction and disposed on at least one of an upper portion or a lower portion of the cell stack to be spaced from the first clamping member and to extend in the first direction, and a coupling portion configured to couple each of the first and second clamping members to each of the first and second end plates and to couple the side cover to the enclosure. The first clamping member may include an insulating portion disposed on the edge portion to extend from a region on the upper portion of the cell stack to a region on the side portion of the cell stack and a metal portion disposed on a portion of the insulating portion disposed on the upper portion of the cell stack to be coupled to the coupling portion.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The accompanying drawings, which are included to provide a further understanding of the present disclosure and are incorporated in and form a part of the present application, illustrate embodiment(s) of the present disclosure and together with the description serve to explain the principle of the present disclosure. In the drawings:

FIG. 1A is a perspective view of a fuel cell according to an exemplary embodiment of the present disclosure:

FIG. 1B is an exploded perspective view of the fuel cell shown in FIG. 1A;

FIG. 2 is a cross-sectional view of first and second end plates, current collectors, and a cell stack in the fuel cell shown in FIG. 1A and FIG. 1B;

FIG. 3A is a perspective view showing coupling of an exemplary embodiment of a plurality of clamping members to the cell stack in the fuel cell shown in FIG. 1B;

FIG. 3B is a front view showing coupling of the plurality of clamping members to the cell stack shown in FIG. 3A;

FIG. 4 is a front view showing coupling of another exemplary embodiment of the plurality of clamping members to the cell stack in the fuel cell shown in FIG. 1B;

FIG. 5A is a perspective view of a first clamping member according to an exemplary embodiment of the present disclosure;

FIG. 5B is a front view of the first clamping member shown in FIG. 5A;

FIG. 6 is a perspective view of a second clamping member according to an exemplary embodiment of the present disclosure;

FIG. 7A is a perspective view showing coupling of another exemplary embodiment of the plurality of clamping members to the cell stack in the fuel cell shown in FIG. 1B;

FIG. 7B is a front view of the cell stack and the plurality of clamping members shown in FIG. 7A;

FIG. 8 is a cross-sectional view taken along line I-I′ in the exemplary embodiment shown in FIG. 1A;

FIG. 9 is a cross-sectional view of a fuel cell according to an exemplary embodiment of the present disclosure;

FIG. 10 is a cross-sectional view of a fuel cell according to another exemplary embodiment of the present disclosure;

FIG. 11 is a cross-sectional view of a fuel cell according to yet another exemplary embodiment of the present disclosure;

FIG. 12 is a perspective view of a fuel cell according to a comparative example;

FIG. 13 is a graph indicating an impulse; and

FIG. 14 is a perspective view of a fuel cell according to another comparative example.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure will now be described more fully hereinafter with reference to the accompanying drawings, in which various exemplary embodiments of the present disclosure are shown. The examples, however, may be embodied in various forms and should not be construed as being limited to the exemplary embodiments set forth herein. Rather, these embodiments are provided so that the present disclosure will be more thorough and complete, and will more fully convey the scope of the present disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

Furthermore, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, a fuel cell according to an exemplary embodiment will be described with reference to the accompanying drawings. The fuel cell will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the exemplary embodiments are not limited thereto. That is, the x-axis, the y-axis, and the z-axis may intersect each other obliquely. Hereinafter, for convenience of description, the x-axis direction will be referred to as a “first direction”, the y-axis direction will be referred to as a “second direction”, and the z-axis direction will be referred to as a “third direction”.

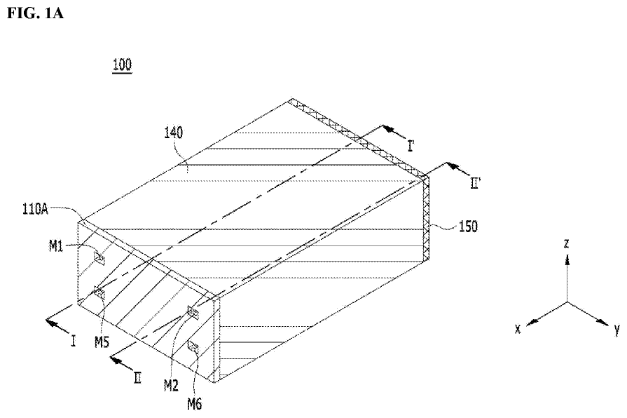

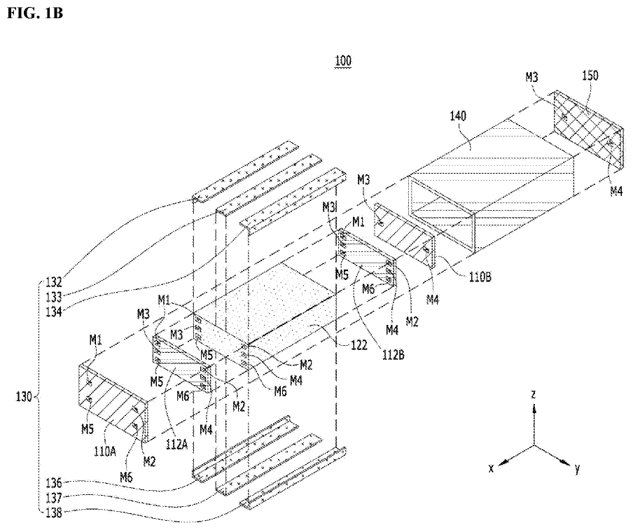

FIG. 1A is a perspective view of a fuel cell 100 according to an exemplary embodiment of the present disclosure, and FIG. 1B is an exploded perspective view of the fuel cell 100 shown in FIG. 1A.

The fuel cell 100 shown in FIG. 1A and FIG. 1B may include first and second end plates (or pressing plates or compression plates) 110A and 110B, a cell stack (or a power generation module) 122, and a plurality of clamping members 130. Furthermore, the fuel cell 100 may further include current collectors 112A and 112B.

The fuel cell 100 may be, for example, a polymer electrolyte membrane fuel cell (or a proton exchange membrane fuel cell) (PEMFC), which has been studied most extensively as a power source for driving vehicles. However, the exemplary embodiments are not limited to any specific form of the fuel cell 100.

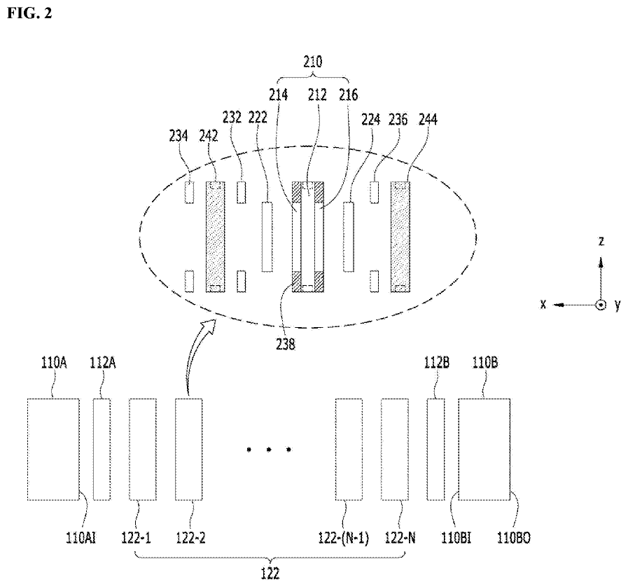

FIG. 2 is a cross-sectional view of the first and second end plates 110A and 110B, the current collectors 112A and 112B, and the cell stack 122 in the fuel cell 100 shown in FIG. 1A and FIG. 1B.

Referring to FIG. 2, the cell stack 122 may include a plurality of unit cells 122-1 to 122-N, which are stacked in the first direction (e.g., the x-axis direction). Here, “N” is a positive integer of 1 or greater, and may range from several tens to several hundred. However, the exemplary embodiments are not limited to any specific value of “N”.

Each unit cell 122-n may be configured to generate 0.6 volts to 1.0 volts of electricity, on average 0.7 volts of electricity. Here, 1≤n≤N. Therefore, “N” may be determined depending on the intensity of power to be supplied from the fuel cell 100 to a load. Here, “load” may refer to a part requiring power in a vehicle.

Each unit cell 122-n may include a membrane electrode assembly (MEA) 210, gas diffusion layers (GDLs) 222 and 224, internal gaskets 232, 234, and 236, and separators (or bipolar plates) 242 and 244.

The membrane electrode assembly 210 includes a structure in which catalyst electrode layers, in which electrochemical reactions occur, are attached to both sides of an electrolyte membrane through which hydrogen ions move. In detail, the membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. Furthermore, the membrane electrode assembly 210 may further include a sub-gasket 238.

The polymer electrolyte membrane 212 is disposed between the fuel electrode 214 and the air electrode 216.

Hydrogen as a fuel of the fuel cell 100 may be supplied to the fuel electrode 214 through the first separator 242, and air containing oxygen as an oxidizer may be supplied to the air electrode 216 through the second separator 244.

The hydrogen supplied to the fuel electrode 214 is decomposed into hydrogen ions (protons) (H+) and electrons (e−) by the catalyst. The hydrogen ions alone may be selectively transferred to the air electrode 216 through the polymer electrolyte membrane 212, and at the same time, the electrons may be transferred to the air electrode 216 through the gas diffusion layers 222 and 224 and the first and second separators 242 and 244, which are conductors. To realize the above operation, a catalyst layer may be applied to each of the fuel electrode 214 and the air electrode 216. The movement of the electrons described above causes the electrons to flow through an external conductive wire, thus generating current. That is, the fuel cell 100 may generate electric power due to the electrochemical reaction between hydrogen as the fuel and oxygen contained in the air.

In the air electrode 216, the hydrogen ions supplied through the polymer electrolyte membrane 212 and the electrons transferred through the first and second separators 242 and 244 meet oxygen in the air supplied to the air electrode 216, thus causing a reaction that generates water (hereinafter referred to as “product water” or “condensed water”). The product water generated in the air electrode 216 may penetrate the polymer electrolyte membrane 212 and may be transferred to the fuel electrode 214.

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The first and second gas diffusion layers 222 and 224 are configured to uniformly distribute hydrogen and oxygen, which are reactant gases, and to transfer the generated electrical energy. To the present end, the first and second gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 is configured to diffuse and uniformly distribute hydrogen supplied as a reactant gas through the first separator 242, and may be electrically conductive.

The second gas diffusion layer 224 is configured to diffuse and uniformly distribute air supplied as a reactant gas through the second separator 244, and may be electrically conductive.

Each of the first and second gas diffusion layers 222 and 224 may be a microporous layer in which fine carbon fibers are combined. However, the exemplary embodiments are not limited to any specific forms of the first and second gas diffusion layers 222 and 224.

The internal gaskets 232, 234, and 236 is configured to maintain airtightness and clamping pressure of the cell stack at an appropriate level with respect to the reactant gases and the coolant, to disperse stress when the first and second separators 242 and 244 are stacked, and to independently seal flow paths. Accordingly, because airtightness and watertightness are maintained by the internal gaskets 232, 234, and 236, the flatness of the surfaces that are adjacent to the cell stack 122, which generates power, may be secured, and thus surface pressure may be distributed uniformly over the reaction surface of the cell stack 122.

The first and second separators 242 and 244 may be configured to move the reactant gases and the cooling medium and to separate each of the unit cells from the other unit cells. Furthermore, the first and second separators 242 and 244 may be configured to structurally support the membrane electrode assembly 210 and the gas diffusion layers 222 and 224 and to collect the generated current and transfer the collected current to the current collectors 112A and 112B.

The first and second separators 242 and 244 may be spaced from each other in the first direction (e.g., the x-axis direction) and may be disposed outside the first and second gas diffusion layers 222 and 224, respectively. That is, the first separator 242 may be disposed on the left side of the first gas diffusion layer 222, and the second separator 244 may be disposed on the right side of the second gas diffusion layer 224.

The first separator 242 is configured to supply hydrogen as a reactant gas to the fuel electrode 214 through the first gas diffusion layer 222. The second separator 244 is configured to supply air as a reactant gas to the air electrode 216 through the second gas diffusion layer 224.

Furthermore, each of the first and second separators 242 and 244 may form a channel through which a cooling medium (e.g., coolant) is capable of flowing.

The first and second end plates 110A and 110B may be disposed on respective side end portions of the cell stack 122, and may support and fix the plurality of unit cells. That is, the first end plate 110A may be disposed on one of both side end portions of the cell stack 122, and the second end plate 110B may be disposed on the other of both side end portions of the cell stack 122.

The current collectors 112A and 112B may be disposed between the cell stack 122 and the internal side surfaces 110AI and 110BI of the first and second end plates 110A and 110B that face the cell stack 122. The current collectors 112A and 112B are configured to collect electrical energy generated by the flow of electrons in the cell stack 122 and to supply the electrical energy to a load of the vehicle in which the fuel cell 100 is used. A current-collecting terminal may be disposed on the upper end portion of each of the current collectors 112A and 112B to transfer electric power to the outside thereof, and the electric power may be transferred via a high-voltage junction box through a bus bar and a terminal block.

Furthermore, bypass plates and end cell heaters may be further disposed between the first end plate 110A and the current collector 112A and between the second end plate 110B and the current collector 112B.

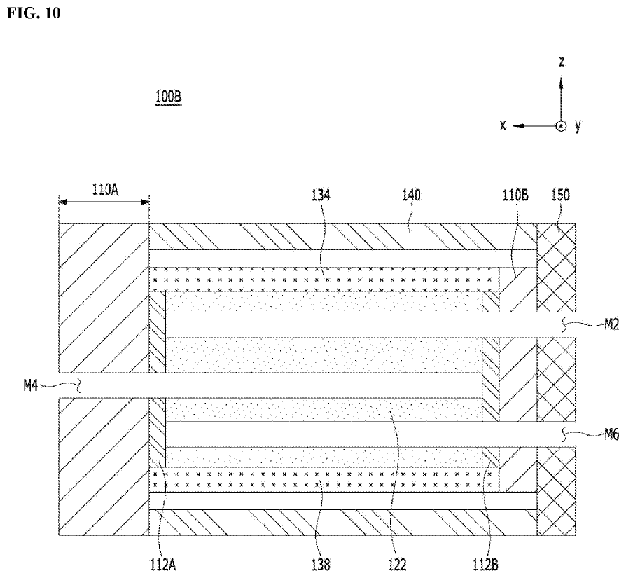

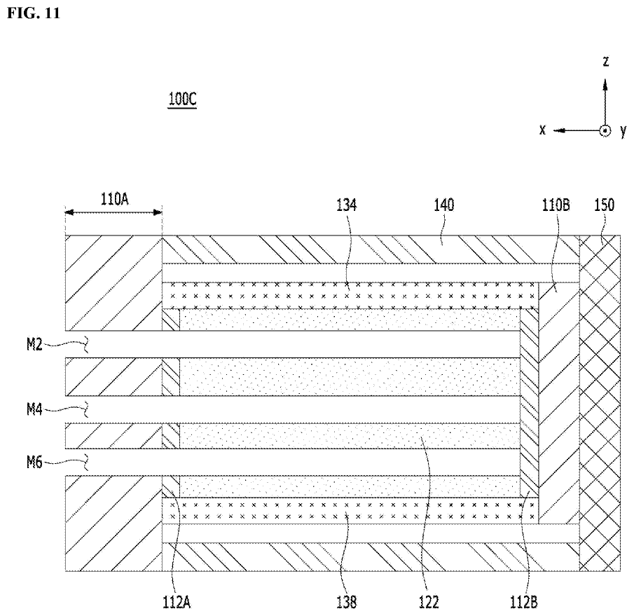

At least one of the first end plate 110A or the second end plate 110B included in the fuel cell 100 may include first, second, third, fourth, fifth and sixth manifolds M1, M2, M3, M4, M5 and M6. For example, as shown in FIG. 1A and FIG. 1B, the first end plate 110A may include first, second, fifth, and sixth manifolds M1, M2, M5, and M6, and the second end plate 110B may include third and fourth manifolds M3 and M4. Alternatively, as shown in FIG. 10 to be described later, the second end plate 110B may include first, second, fifth, and sixth manifolds M1, M2, M5, and M6, and the first end plate 110A may include third and fourth manifolds M3 and M4. Alternatively, as shown in FIG. 11 to be described later, the first end plate 110A may include all of the first, second, third, fourth, fifth and sixth manifolds M1, M2, M3, M4, M5 and M6, and the second end plate 110B may include no manifold. However, the fuel cell 100 according to the exemplary embodiment of the present disclosure is not limited to any specific disposition structure of the first, second, third, fourth, fifth and sixth manifolds M1, M2, M3, M4, M5 and M6.

The first and second manifolds M1 and M2 may be gas inflow manifolds (or gas inlet manifolds), through which reactant gases are introduced into the cell stack 122 from the outside of the fuel cell 100. For example, hydrogen as a reactant gas may be introduced into the cell stack 122 from the outside through one of the first and second manifolds M1 and M2, and oxygen as a reactant gas may be introduced into the cell stack 122 from the outside through the other of the first and second manifolds M1 and M2.

One of the third and fourth manifolds M3 and M4 may be a cooling medium inflow manifold (or a cooling medium inlet manifold), through which a cooling medium is introduced into the fuel cell 100 from the outside thereof to maintain the temperature of the cell stack 122, and the other of the third and fourth manifolds M3 and M4 may be a cooling medium outflow manifold (or a cooling medium outlet manifold), through which the cooling medium is discharged from the fuel cell 100 to the outside thereof.

The fifth and sixth manifolds M5 and M6 may be gas outflow manifolds (or gas outlet manifolds), through which the reactant gases that have been completely used in the cell stack 122 and product water as a byproduct are discharged to the outside of the cell stack 122. For example, hydrogen as a reactant gas may be discharged to the outside of the cell stack 122 together with the product water through one of the fifth and sixth manifolds M5 and M6, and oxygen as a reactant gas may be discharged to the outside of the cell stack 122 together with the product water through the other of the fifth and sixth manifolds M5 and M6.

In the instant case, the gas outflow manifolds M5 and M6 may be disposed below the gas inflow manifolds M1 and M2.

Furthermore, the gas inflow manifold and the gas outflow manifold, through which the same reactant gas is introduced and discharged, may be spaced from each other in an oblique direction thereof.

For example, in the case in which oxygen as a reactant gas is introduced through the first manifold M1, the oxygen as a reactant gas may be discharged through the sixth manifold M6, which is spaced from the first manifold M1 in the oblique direction. Also, in the case in which hydrogen as a reactant gas is introduced through the second manifold M2, the hydrogen as a reactant gas may be discharged through the fifth manifold M5, which is spaced from the second manifold M2 in the oblique direction. On the other hand, in the case in which hydrogen as a reactant gas is introduced through the first manifold M1, the hydrogen as a reactant gas may be discharged through the sixth manifold M6, which is spaced from the first manifold M1 in the oblique direction. Also, in the case in which oxygen as a reactant gas is introduced through the second manifold M2, the oxygen as a reactant gas may be discharged through the fifth manifold M5, which is spaced from the second manifold M2 in the oblique direction.

Referring back to FIG. 1A and FIG. 1B, the fuel cell 100 according to the exemplary embodiment of the present disclosure may further include a side cover 150 and an enclosure 140. The side cover 150 may be disposed between the second end plate 110B and the enclosure 140 and may be coupled to the second end plate 110B and the enclosure 140.

One end portion and the other end portion of the enclosure 140 may be coupled to the first end plate 110A and the side cover 150, respectively, to enclose the cell stack 122, the current collectors 112A and 112B, and the second end plate 110B. In the present way, the enclosure 140 and the side cover 150 may be configured as a housing of the fuel cell 100 together with the first end plate 110A.

Furthermore, the plurality of clamping members 130 is configured to clamp the plurality of unit cells in the first direction (e.g., the x-axis direction) together with the first and second end plates 110A and 110B. For example, the plurality of clamping members 130 for clamping the plurality of unit cells may be formed in a bar shape, but the exemplary embodiments are not limited to any specific shape of the plurality of clamping members 130 in the first direction. Therefore, the clamping pressure of the cell stack 122 may be maintained by the end plates 110A and 110B including a rigid body structure and the clamping members 130.

Hereinafter, the plurality of clamping members 130 according to the exemplary embodiment and parts connected to the clamping members 130 will be described with reference to the accompanying drawings.

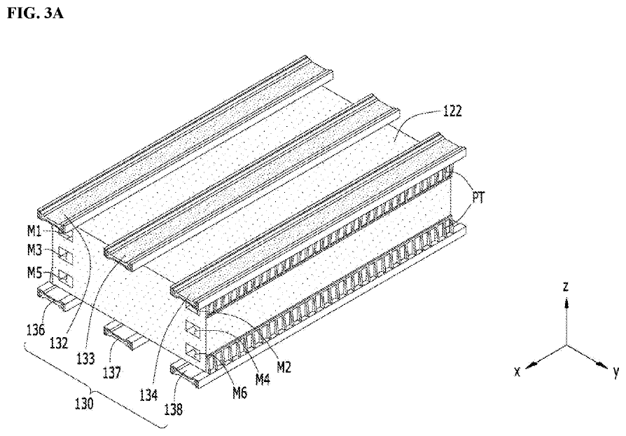

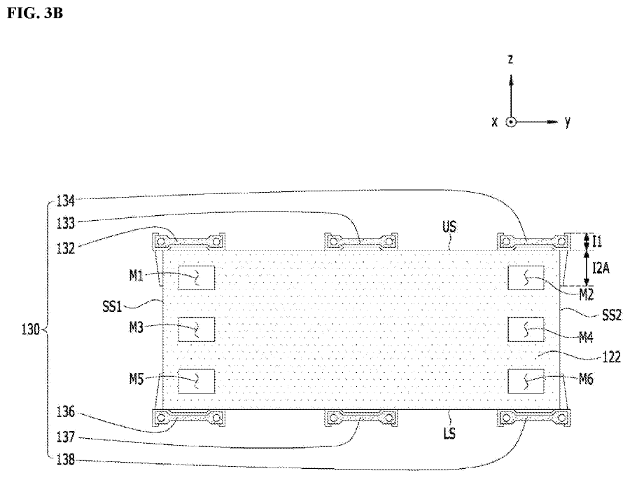

FIG. 3A is a perspective view showing coupling of an exemplary embodiment of the plurality of clamping members 130 to the cell stack 122 in the fuel cell 100 shown in FIG. 1B, and FIG. 3B is a front view showing coupling of the plurality of clamping members 130 to the cell stack 122 shown in FIG. 3A.

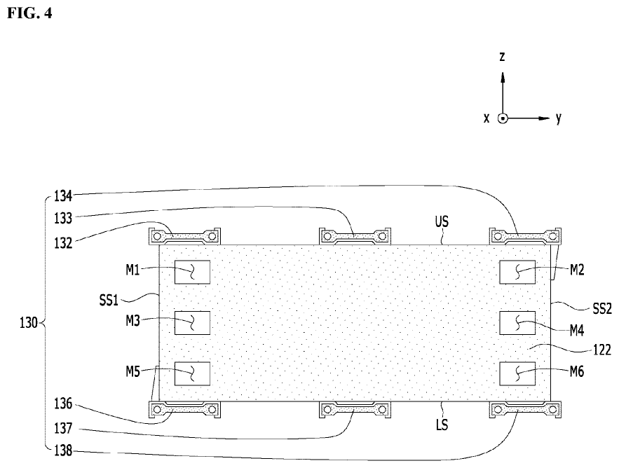

FIG. 4 is a front view showing coupling of another exemplary embodiment of the plurality of clamping members 130 to the cell stack 122 in the fuel cell 100 shown in FIG. 1B.

The plurality of clamping members 130 may include two types of clamping members, that is, a first clamping member and a second clamping member.

The first clamping member may clamp the plurality of unit cells in the first direction, and may be disposed on at least one of edge portions of the cell stack 122 to extend in the first direction. To the present end, the first clamping member may include an insulating portion (corresponding to the first and second insulating portions explained later) disposed from on the cell stack 122 to a side portion of the cell stack 122 at an edge portion of the cell stack 122, and a first metal portion disposed on the insulating portion, which is disposed on the cell stack at the edge portion of the cell stack 122.

The second clamping member may clamp the plurality of unit cells in the first direction, and may be disposed on at least one of an upper surface or a lower surface of the cell stack 122 to be spaced from the first clamping member and to extend in the first direction. To the present end, the second clamping member may include a third insulating portion disposed on the cell stack 122 and a second metal portion disposed on the third insulating portion.

Referring to FIGS. 3B and 4, the cell stack 122 may include an upper surface US, a lower surface LS, and first and second side surfaces SS1 and SS2. The lower surface LS is a surface opposite to the upper surface US in the third direction intersecting each of the first direction and the second direction, the first side surface SS1 is a surface located between the upper surface US and the lower surface LS, and the second side surface SS2 is a surface opposite to the first side surface SS1 in the second direction.

The plurality of clamping members 130 may include first, second, third, fourth, fifth and sixth clamping bars 132, 134, 136, 138, 133, and 137.

The first clamping bar 132 may be disposed on a boundary at which the upper surface US and the first side surface SS1 are contiguous with each other, the second clamping bar 134 may be disposed on a boundary at which the upper surface US and the second side surface SS2 are contiguous with each other, the third clamping bar 136 may be disposed on a boundary at which the lower surface LS and the first side surface SS1 are contiguous with each other, and the fourth clamping bar 138 may be disposed on a boundary at which the lower surface LS and the second side surface SS2 are contiguous with each other. The fifth clamping bar 133 may be disposed on the upper surface US of the cell stack 122 and may be disposed between the first clamping bar 132 and the second clamping bar 134. The sixth clamping bar 137 may be disposed on the lower surface LS of the cell stack 122 and may be disposed between the third clamping bar 136 and the fourth clamping bar 138.

According to an exemplary embodiment of the present disclosure, as shown in FIGS. 1B, 3A, and 3B, each of the first, second, third and fourth clamping bars 132, 134, 136, and 138 includes the first and second insulating portions and the first metal portion, and thus may correspond to the first clamping member, and each of the fifth and sixth clamping bars 133 and 137 includes the third insulating portion and the second metal portion, and thus may correspond to the second clamping member.

According to another exemplary embodiment of the present disclosure, as shown in FIG. 4, each of the second and third clamping bars 134 and 136 includes the first and second insulating portions and the first metal portion, and thus may correspond to the first clamping member, and each of the first, fourth, fifth and sixth clamping bars 132, 138, 133, and 137 includes the third insulating portion and the second metal portion, and thus may correspond to the second clamping member.

According to various exemplary embodiments of the present disclosure, unlike what is shown in the drawings, each of the first and fourth clamping bars 132 and 138 may correspond to the first clamping member, and each of the second, third, fifth, and sixth clamping bars 134, 136, 133, and 137 may correspond to the second clamping member.

Hereinafter, each of the first and second clamping members according to the exemplary embodiment of the present disclosure will be described with reference to the accompanying drawings.

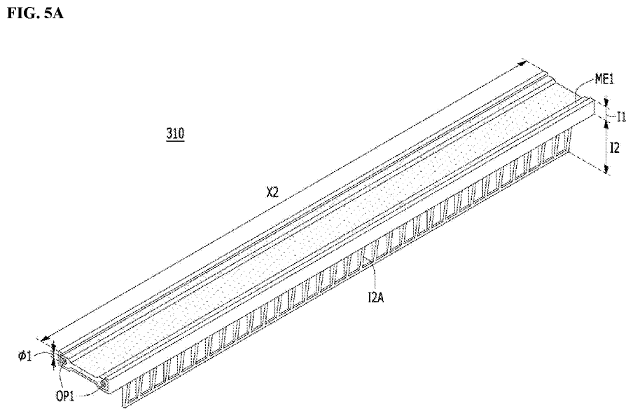

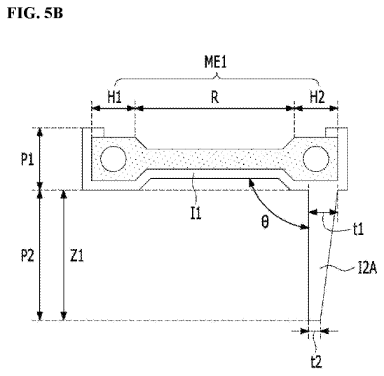

FIG. 5A is a perspective view of a first clamping member 310 according to an exemplary embodiment of the present disclosure, FIG. 5B is a front view of the first clamping member 310 shown in FIG. 5A.

The first clamping member 310 shown in FIG. 5A and FIG. 5B may correspond to an exemplary embodiment of each of the first, second, third and fourth clamping bars 132, 134, 136, and 138 shown in FIGS. 1B, 3A, and 3B or an exemplary embodiment of each of the second and third clamping bars 134 and 136 shown in FIG. 4.

The first clamping member 310 may include a first portion P1 and a second portion P2.

The first portion P1 is a portion which is disposed on or under the cell stack 122 at a position adjacent to an edge portion of the cell stack 122. The second portion P2 is a portion which is bent from the first portion P1 and is disposed on a side portion of the cell stack 122.

The first portion P1 may include a first metal portion ME1 and a first insulating portion I1.

The first metal portion ME1 may include a center portion R and peripheral portions H1 and H2. According to the exemplary embodiment of the present disclosure, the thickness of the center portion R in the third direction may be less than the thickness of each of the peripheral portions H1 and H2 in the third direction. That is, the first metal portion ME1 may include a shape in which the center portion R thereof is depressed. According to another exemplary embodiment of the present disclosure, unlike what is shown in the drawings, the peripheral portions H1 and H2 and the center portion R may include the same thickness in the third direction.

The first insulating portion I1 may be disposed between the first metal portion ME1 and the cell stack 122. For example, as shown in the drawings, the first insulating portion I1 may be disposed to cover the lower surface, the side surface, and a portion of the upper surface of the first metal portion ME1. Alternatively, unlike what is shown in the drawings, the first insulating portion I1 may be disposed to cover only the lower surface of the first metal portion ME1.

The second portion P2 may include a second insulating portion I2A disposed on a side portion of the cell stack 122. When the first clamping member 310 corresponds to the second or fourth clamping bar 134 or 138 shown in FIGS. 1B, 3A, and 3B or the second clamping bar 134 shown in FIG. 4, the second insulating portion I2A may be disposed on the second side surface SS2 of the cell stack 122. However, when the first clamping member 310 corresponds to the first or third clamping bar 132 or 136 shown in FIGS. 1B, 3A, and 3B or the third clamping bar 136 shown in FIG. 4, the second insulating portion I2A may be disposed on the first side surface SS1 of the cell stack 122.

According to the exemplary embodiment of the present disclosure, as shown in the drawings, the first insulating portion I1 and the second insulating portion I2A may be integrally formed with each other. Alternatively, unlike what is shown in the drawings, the first insulating portion I1 and the second insulating portion I2A may be provided separately from each other.

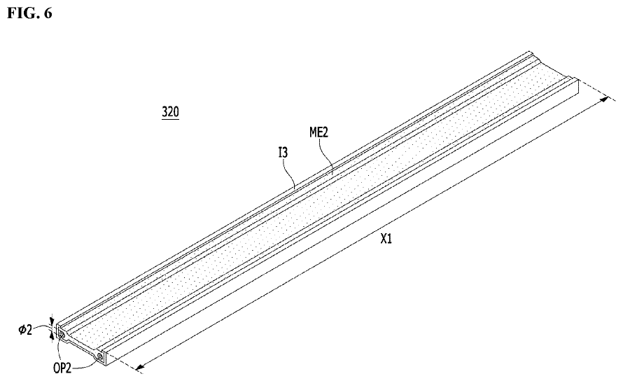

FIG. 6 is a perspective view of a second clamping member 320 according to an exemplary embodiment of the present disclosure.

The second clamping member 320 shown in FIG. 6 may correspond to an exemplary embodiment of each of the fifth and sixth clamping bars 133 and 137 shown in FIGS. 1B, 3A, 3B, and 4 or an exemplary embodiment of each of the first and fourth clamping bars 132 and 138 shown in FIG. 4.

The second clamping member 320 may include a second metal portion ME2 and a third insulating portion I3. Each of the first, second, and third insulating portions I1, I2, and I3 may be made of an electrically insulative material (e.g., plastic), and each of the first and second metal portions ME1 and ME2 may be made of an electrically conductive metal material.

The third insulating portion I3 may be disposed between the second metal portion ME2 and the cell stack 122. If the second clamping member 320 corresponds to the fifth clamping bar 133 shown in FIGS. 1B, 3A, 3B, and 4 or the first clamping bar 132 shown in FIG. 4, the third insulating portion I3 may be disposed between the second metal portion ME2 and the upper surface US of the cell stack 122. Alternatively, if the second clamping member 320 corresponds to the sixth clamping bar 137 shown in FIGS. 1B, 3A, 3B, and 4 or the fourth clamping bar 138 shown in FIG. 4, the third insulating portion I3 may be disposed between the second metal portion ME2 and the lower surface LS of the cell stack 122.

The second metal portion ME2 may include the same shape as the first metal portion ME1, and the third insulating portion I3 may include the same shape as the first insulating portion I1. However, the exemplary embodiments are not limited thereto.

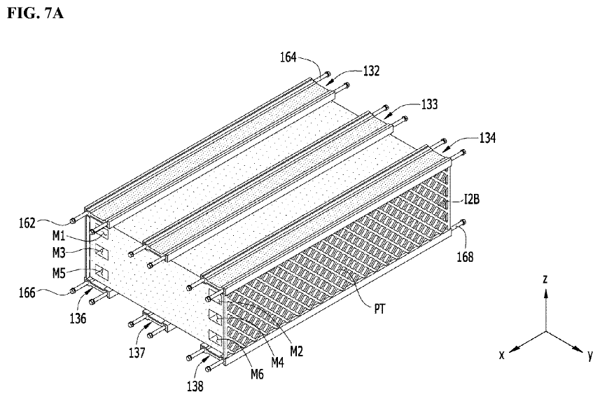

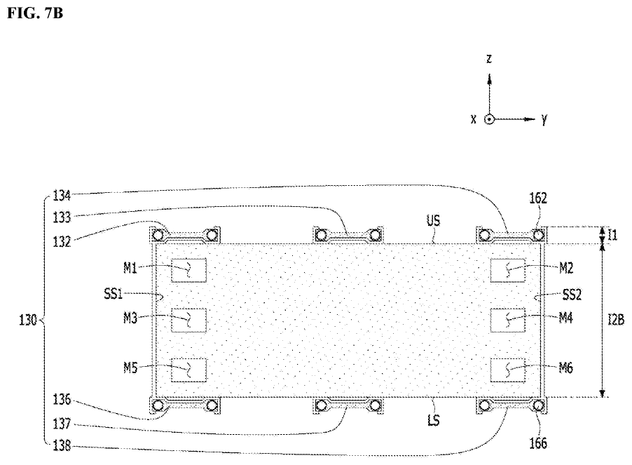

FIG. 7A is a perspective view showing coupling of another exemplary embodiment of the plurality of clamping members 130 to the cell stack 122 in the fuel cell 100 shown in FIG. 1B, and FIG. 7B is a front view of the cell stack 122 and the plurality of clamping members 130 shown in FIG. 7A.

According to an exemplary embodiment of the present disclosure, as shown in FIGS. 1A, 3A, 3B, and 4, the second portion P2 may cover only a portion of the side surface SS1 or SS2 of the cell stack 122.

That is, as shown in FIGS. 1A, 3A, and 3B, the second portion P2 of the first clamping bar 132 covers an upper portion of the first side surface SS1 of the cell stack 122, and the second portion P2 of the third clamping bar 136 covers a lower portion of the first side surface SS1 of the cell stack 122. In the instant case, as shown in the drawings, the second portion P2 of the first clamping bar 132 and the second portion P2 of the third clamping bar 136 cover only a portion of the first side surface SS1 of the cell stack 122 and not the entire area thereof.

Furthermore, as shown in FIGS. 1A, 3A, and 3B, the second portion P2 of the second clamping bar 134 covers an upper portion of the second side surface SS2 of the cell stack 122, and the second portion P2 of the fourth clamping bar 138 covers a lower portion of the second side surface SS2 of the cell stack 122. In the instant case, as shown in the drawings, the second portion P2 of the second clamping bar 134 and the second portion P2 of the fourth clamping bar 138 cover only a portion of the second side surface SS2 of the cell stack 122 and not the entire area thereof.

Furthermore, as shown in FIG. 4, the second portion P2 of the second clamping bar 134 covers an upper portion of the second side surface SS2 of the cell stack 122 and the second portion P2 of the third clamping bar 136 covers a lower portion of the first side surface SS1 of the cell stack 122. In the instant case, the second portion P2 of the second clamping bar 134 covers only a portion of the second side surface SS2 of the cell stack 122 and not the entire area thereof, and the second portion P2 of the third clamping bar 136 covers only a portion of the first side surface SSI of the cell stack 122 and not the entire area thereof.

Therefore, as shown in FIGS. 1A, 3A, and 3B, the second insulating portion I2A as the second portion P2 of the first clamping bar 132 and the second insulating portion I2A as the second portion P2 of the third clamping bar 136 may be spaced from each other in the third direction, and the second insulating portion I2A as the second portion P2 of the second clamping bar 134 and the second insulating portion I2A as the second portion P2 of the fourth clamping bar 138 may be spaced from each other in the third direction.

Furthermore, an angle θ between the second portion P2 and the first portion P1 may be 90° or less.

According to another exemplary embodiment of the present disclosure, as shown in FIG. 7A and FIG. 7B, the entire area of each of the side surfaces SS1 and SS2 of the cell stack 122 may be covered by the second portion P2.

That is, the second insulating portion I2B as the second portion P2 of the first clamping bar 132 and the second insulating portion I2B as the second portion P2 of the third clamping bar 136 may be integrally formed with each other, and the second insulating portion I2B as the second portion P2 of the second clamping bar 134 and the second insulating portion I2B as the second portion P2 of the fourth clamping bar 138 may be integrally formed with each other.

According to the exemplary embodiment of the present disclosure, the second portion P2 of the first clamping member may include a pattern PT for protecting the cell stack 122 from external impact (hereinafter referred to as an “impact mitigation pattern”). For example, the impact mitigation pattern may include a zig-zag shape, as shown in FIG. 3A, or may include a lattice shape, as shown in FIG. 7A. However, the exemplary embodiments are not limited to any specific shape of the impact mitigation pattern.

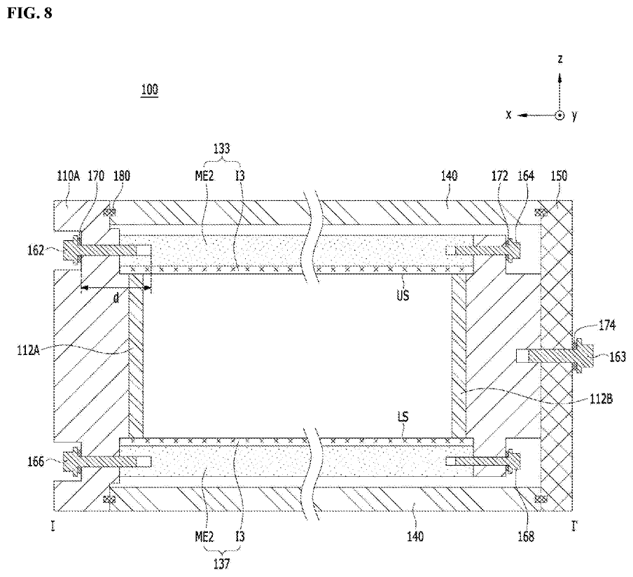

FIG. 8 is a cross-sectional view taken along line I-I′ in the exemplary embodiment shown in FIG. 1A.

The fuel cell 100 according to the exemplary embodiment of the present disclosure may further include a coupling portion. For convenience of explanation, illustration of the coupling portion is omitted in FIGS. 1A, 1B, and 2.

The coupling portion is configured to couple the first and second clamping members 310 and 320 to the first and second end plates 110A and 110B and to couple the second end plate 110B to the side cover 150.

According to another exemplary embodiment of the present disclosure, although not shown in the drawings, the coupling portion may couple the enclosure 140 to the first end plate 110A and to the side cover 150.

According to the exemplary embodiment of the present disclosure, the coupling portion may include first, second, and third coupling portions.

The first coupling portion couples the first end plate 110A to one end portion of the clamping member. The second coupling portion couples the second end plate 110B to the other end portion of the clamping member.

Each of the first, second, third, and fourth clamping bars 132, 134, 136, and 138 as the clamping members includes the same shape as the fifth and sixth clamping bars 133 and 137 shown in FIG. 8, that is, includes one end portion connected to the first coupling portion and the other end portion connected to the second coupling portion.

For example, the first coupling portion may include first and second bolts 162 and 166, and the second coupling portion may include third and fourth bolts 164 and 168. However, the exemplary embodiments are not limited thereto.

The third coupling portion couples the side cover 150 to the second end plate 110B. As shown in FIG. 8, the third coupling portion may include a fifth bolt 163. However, the exemplary embodiments are not limited thereto.

Each of the first, second, third, fourth and fifth bolts 162, 164, 166, 168, and 163 may be a flange bolt.

Furthermore, the first, second, and third coupling portions may further include sealing washers. That is, the first, second, and third coupling portions may include first, second, and third sealing washers, respectively.

The first sealing washer 170 may be disposed between the internal circumferential surface of an insertion hole OP2 formed to allow each of the first and second bolts 162 and 166, which are flange bolts, to pass therethrough or to be inserted thereinto and the external circumferential surface of each of the flange bolts 162 and 166. Similar to the fifth and sixth clamping bars 133 and 137 shown in FIG. 8, in each of the first, second, third and fourth clamping bars 132, 134, 136, and 138, the first sealing washer 170 may be disposed between the internal circumferential surface of an insertion hole OP1 formed to allow the flange bolt to pass therethrough or to be inserted thereinto and the external circumferential surface of the flange bolt.

The second sealing washer 172 may be disposed between the internal circumferential surface of an insertion hole formed to allow each of the third and fourth bolts 164 and 168, which are flange bolts, to pass therethrough or to be inserted thereinto and the external circumferential surface of each of the flange bolts 164 and 168. Similar to the fifth and sixth clamping bars 133 and 137 shown in FIG. 8, in each of the first, second, third and fourth clamping bars 132, 134, 136, and 138, the second sealing washer 172 may be disposed between the internal circumferential surface of an insertion hole formed to allow the flange bolt to pass therethrough or to be inserted thereinto and the external circumferential surface of the flange bolt.

The third sealing washer 174 may be disposed between the internal circumferential surface of an insertion hole formed to allow the fifth bolt 163, which is a flange bolt, to pass therethrough or to be inserted thereinto and the external circumferential surface of the flange bolt 163.

The first, second, and third sealing washers 170 to 174 may be made of a plastic-based material. However, the exemplary embodiments are not limited to any specific material of the washers.

Furthermore, the fuel cell according to the exemplary embodiment of the present disclosure may further include external gaskets 180. The external gaskets 180 may be disposed between the first end plate 110A and the enclosure 140 and between the side cover 150 and the enclosure 140.

Hereinafter, various embodiments of the fuel cell 100 will be described with reference to the accompanying drawings.

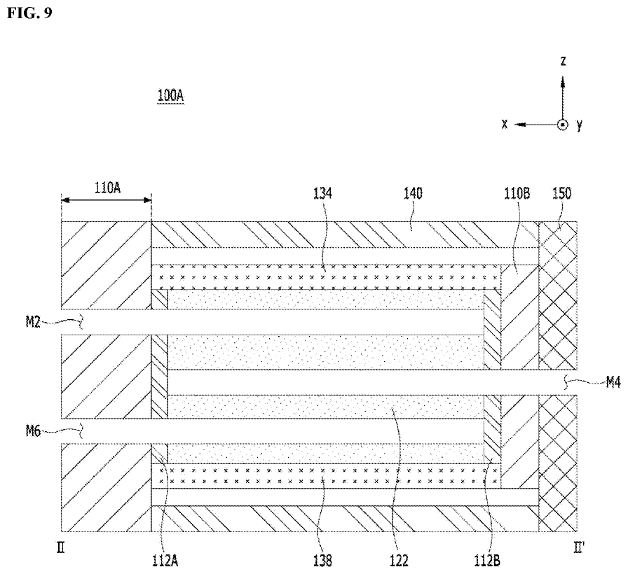

FIG. 9 is a cross-sectional view of a fuel cell 100A according to an exemplary embodiment of the present disclosure, FIG. 10 is a cross-sectional view of a fuel cell 100B according to another exemplary embodiment of the present disclosure, and FIG. 11 is a cross-sectional view of a fuel cell 100C according to yet another exemplary embodiment of the present disclosure.

In detail, FIG. 9 shows a cross-section of an exemplary embodiment 100A obtained by cutting the fuel cell 100 shown in FIG. 1A along line II-II′, FIG. 10 shows a cross-section of another exemplary embodiment 100B obtained by cutting the fuel cell 100 shown in FIG. 1A along line II-II′, and FIG. 11 shows a cross-section of various exemplary embodiments 100C obtained by cutting the fuel cell 100 shown in FIG. 1A along line II-II′.

The same components as those shown in FIG. 1A and FIG. 1B are denoted by the same reference numerals, and duplicate description thereof will be omitted. Furthermore, for convenience of description, illustration of the coupling portions are omitted in FIGS. 9 to 11.

Each of the fuel cells 100A, 100B, and 100C shown in FIG. 9, FIG. 10 and FIG. 11 includes first and second end plates 110A and 110B, current collectors 112A and 112B, a cell stack 122, clamping members 134 and 138, an enclosure 140, and a side member 150.

Each of the fuel cells 100B and 100C includes the same configuration as the fuel cell 100A, except for disposition of the first, second, third, fourth, fifth and sixth manifolds M1, M2, M3, M4, M5 and M6, and performs the same operation as the fuel cell 100A. Differences between the fuel cells will be mainly described. FIG. 10, and FIG. 11 are cross-sectional views of the fuel cells 100B and 100C including manifolds disposed as shown in FIG. 10, and FIG. 11, not in FIG. 9, taken along line II-II′ in FIG. 1A.

Contrary to the fuel cell 100A shown in FIG. 9, the fuel cell 100B shown in FIG. 10 is configured so that the third and fourth manifolds M3 and M4 are disposed in the first end plate 110A and the first, second, fifth, and sixth manifolds M1, M2, M5, and M6 are disposed in the second end plate 110B.

Alternatively, the fuel cell 100C shown in FIG. 11 may be configured so that all of the first, second, third, fourth, fifth and sixth manifolds M1, M2, M3, M4, M5 and M6 are disposed in the first end plate 110A.

The function of each of the first, second, third, fourth, fifth and sixth manifolds M1, M2, M3, M4, M5 and M6 is the same as described above regardless of where the manifolds are disposed, among the first and second end plates 110A and 110B, and thus duplicate description thereof will be omitted.

Hereinafter, a fuel cell according to a comparative example and the fuel cell according to the exemplary embodiment of the present disclosure will be described with reference to the accompanying drawings.

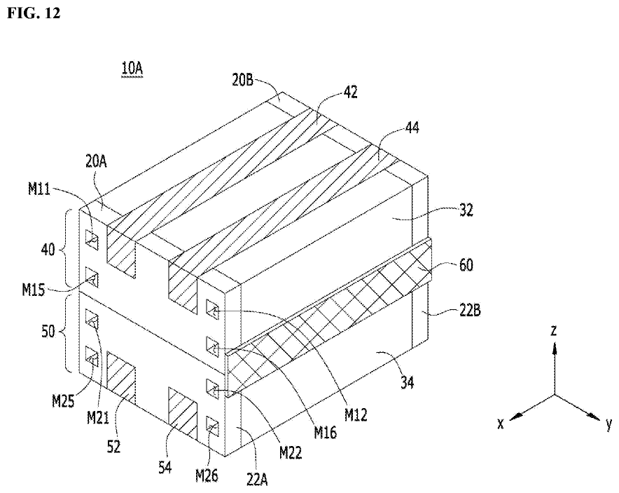

FIG. 12 is a perspective view of a fuel cell 10A according to a comparative example.

The fuel cell 10A according to the comparative example includes first and second unit cell modules 40 and 50 and a plurality of clamping bars 42, 44, 52, and 54. Each of the first and second unit cell modules 40 and 50 includes a cell stack 32 or 34, a first end plate 20A or 22A, a second end plate 20B or 22B, and current collectors. The cell stacks 32 and 34, the first end plates 20A and 22A, the second end plates 20B and 22B, and the current collectors perform the same functions as the cell stack 122, the first end plate 110A, the second end plate 110B, and the current collectors 112A and 112B shown in FIG. 2, respectively, and thus duplicate description thereof will be omitted.

In the case of the fuel cell 10A according to the comparative example, the end plates 20A, 20B, 22A, and 22B including a rigid structure and the clamping bars 42, 44, 52, and 54 restrain both end portions of each of the cell stacks 32 and 34, maintaining clamping force.

Furthermore, to distribute reaction gases and coolant to the first and second unit cell modules 40 and 50, each of the unit cell modules 40 and 50 includes a first manifold M11 or M21, a second manifold M12 or M22, a third manifold M13 or M23, a fourth manifold M14 or M24, a fifth manifold M15 or M25, and a sixth manifold M16 or M26. Because these manifolds are the same as the aforementioned first, second, third, fourth, fifth and sixth manifolds M1, M2, M3, M4, M5 and M6, duplicate description thereof will be omitted.

The fuel cell 10A according to the comparative example may further include an impact beam 60 disposed on side portions of the first and second unit cell modules 40 and 50 stacked in a vertical direction thereof. The impact beam 60 is configured to secure stability of the fuel cell 10A in the event of low-speed collision of a fuel cell vehicle provided with the fuel cell 10A.

However, because the impact beam 60 is mounted on side portions of the unit cell modules, the fuel cell 10A according to the comparative example includes a problem in that the size thereof in the second direction, which is a horizontal direction, increases. Furthermore, mounting of the impact beam 60 may complicate a process of manufacturing the fuel cell 10A and may increase manufacturing cost.

In contrast, according to the exemplary embodiment of the present disclosure, the clamping member, particularly the second portion P2 of the first clamping member 310, may be configured as the impact beam 60. For example, when the fuel cell 100, 100A, 100B, or 100C according to the exemplary embodiment of the present disclosure is mounted in a vehicle, the second portion P2 of the first clamping member 310 may secure sufficient stability against external impact, like the impact beam 60, although the second portion P2 is made of plastic or the like.

To withstand external impact, the second portion P2 of the first clamping member 310 according to the exemplary embodiment of the present disclosure may include the following conditions.

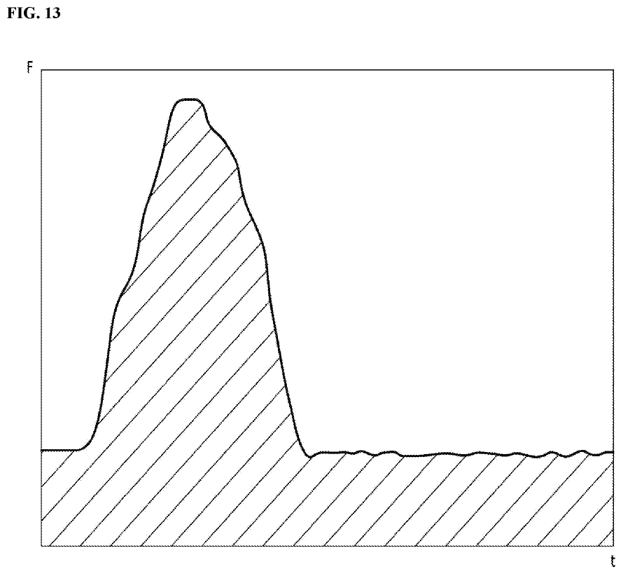

FIG. 13 is a graph indicating an impulse, in which the horizontal axis represents time t and the vertical axis represents force F.

First, it is assumed that the maximum allowable collision speed at which a fuel cell vehicle is capable of traveling without damage to the fuel cell is, for example, 32 kph. Momentary collision at the present maximum allowable collision speed causes an impulse equivalent to the product of acceleration of about 18 g and a time interval of 80 ms.

Assuming that the mass of the cell stack is, for example, 30 kgf, the cell stack needs to withstand an impulse calculated using Equation 1 below.

$$I = F \times Δ t ( F = force , t = time ) \qquad \{ Equation 1 ]$$

Here, F represents force, t represents time, and the impulse is about 2640 J, which corresponds to the size of the hatched area in the graph shown in FIG. 13.

The above impulse is merely illustrative, and the actual impulse may be different from the above impulse depending on the weight of the fuel cell, the coefficient of friction between the stack cells, and clamping force. According to the exemplary embodiment of the present disclosure, to withstand external impact, the second insulating portion I2 (I2A or I2B) as the second portion P2 may include an elastic modulus of 12 GPa at 23° C., impact strength of 10 KJ/m² or greater, and a length Z1 of 2 mm to 3 mm in the third direction.

Furthermore, as shown in FIG. 5B, the second portion P2 may include an inclined shape in which the thickness thereof in the second direction gradually decreases in a direction away from the first portion P1. That is, one end portion of the second insulating portion I2A, which abuts the first metal portion ME1, may have a thickness t1 of 15 mm or greater in the second direction, and the opposite end portion of the second insulating portion I2A may have a thickness t2 of 4 mm or greater in the second direction.

According to the exemplary embodiment of the present disclosure, it is possible to absorb an impulse using the second portion P2 satisfying the above conditions. Therefore, there is no need to separately mount the impact beam 60 shown in FIG. 12 to the fuel cell.

In general, when external impact is applied to a cell stack in the second direction, a plurality of unit cells of the cell stack, which are aligned in the first direction, may be misaligned, and slip may occur, leading to short circuit or gas leakage. According to the exemplary embodiment of the present disclosure, the second portion P2 of the first clamping member 310 is disposed on a side portion of the cell stack 122, instead of the impact beam 60, protecting the cell stack 122 from external impact. Therefore, the fuel cell 100, 100A, 100B, or 100C according to the exemplary embodiment of the present disclosure may be reduced in size in the second direction compared to the comparative example 10A. As a result, the fuel cell according to the exemplary embodiment of the present disclosure may include a reduced size and an improved output density. Furthermore, because the second portion P2 of the first clamping member 310 is naturally disposed on a side portion of the cell stack 122 when the first clamping member 310 is mounted, there is no need to separately mount the impact beam 60. Accordingly, a process of manufacturing the fuel cell according to the exemplary embodiment of the present disclosure may be simplified, and a manufacturing cost thereof may be reduced compared to the comparative example 10A.

Furthermore, because the second portion P2 of the first clamping member 310 according to the exemplary embodiment of the present disclosure includes an impact mitigation pattern, the weight of the second portion P2 may be reduced. As a result, it is possible to reduce the weight of the fuel cell 100, 100A, 100B, and 100C and to more effectively protect the cell stack 122 from external impact while preventing concentration of stress.

Because the clamping bars 42, 44, 52, and 54 shown in FIG. 12 are made of aluminum alloy, it is necessary to insulate portions thereof that contact with the cell to secure insulation resistance. To the present end, insulating plates are disposed between the clamping bars 42, 44, 52, and 54 and the cell stacks 32 and 34. In contrast, according to the exemplary embodiment of the present disclosure, to ensure insulating performance, the clamping bars 132, 134, 136, 138, 133, and 137 may be implemented as resin members manufactured through insert injection molding or may be manufactured by tightly fitting metal inserts into resin plates. Inserts for the clamping bars may be manufactured through an aluminum processing method, such as casting, extrusion, or rolling. Furthermore, the clamping bars 132, 134, 136, 138, 133, and 137 may have lengths X1 and X2, hardness, and tap strength suitable for fixing of the length of the cell stack 122.

The cell stack 122 has compression/tension repulsive force of 2 to 5 tonf. To withstand the present repulsive force, the first, second, third and fourth bolts 162, 164, 166, and 168 may have diameters of, for example, 5 mm or greater, and the insertion holes OP1 and OP2 may have diameters Φ1 and Φ2 of 5 mm or greater, as shown in FIGS. 5A and 6. Furthermore, to have taps for fastening of the first, second, third and fourth bolts 162 to 168, each of the insertion holes OP1 and OP2 may include a depth d of 9 mm or greater. However, the exemplary embodiments are not limited thereto.

The lengths X1 and X2 of the clamping bars 132 to 138 may vary depending on the number of unit cells included in the cell stack 122.

Furthermore, the width and area of each of the first and second metal portions ME1 and ME2 may be determined so that deformation of each of the first and second metal portions ME1 and ME2 by tensile force is equal to or less than 0.1 mm, and the deformation may be determined in accordance with Hooke's law shown in Equation 2 below.

$$δ = \frac{P \cdot L}{E \cdot A} \qquad [ Equation 2 ]$$

Here, δ represents deformation, P represents load, L represents each of the lengths X1 and X2 of the first and second metal portions ME1 and ME2, E represents an elastic modulus, and A represents a cross-sectional area in the first direction and the second direction.

Each of the first, second, and third insulating portions I1 to I3 may include a thickness of 2 mm to 3 mm.

Furthermore, in the case of the fuel cell 10A according to the comparative example, the clamping bars 42, 44, 52, and 54 are disposed at the centers of the cell stacks 32 and 34. In contrast, in the case of the exemplary embodiment 100, 100A, 100B, or 100C, the clamping members 130 are disposed not only at the center portion of the cell stack 122 but also at the edge portions thereof. Therefore, the exemplary embodiment of the present disclosure may uniformly maintain surface pressure of the plurality of unit cells stacked in the first direction compared to the comparative example 10A. That is, because the positions of the surfaces of the cells that react against force of pressing the cells and the load positions of the clamping bars 132, 133, 134, 136, 137, and 138 supporting the cells are adjacent to each other, deformation of the end plates 110A and 110B may be suppressed, and thus the surface pressure of the cell stack 122 may be distributed uniformly.

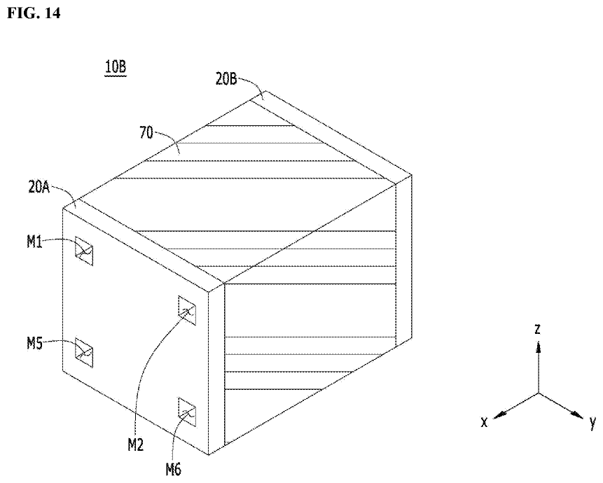

FIG. 14 is a perspective view of a fuel cell 10B according to another comparative example.

The fuel cell 10B shown in FIG. 14 may include first and second end plates 20A and 20B and an enclosure 70. Here, the first and second end plates 20A and 20B perform the same functions as the first and second end plates 110A and 110B shown in FIG. 2, respectively, and manifolds M1, M2, M5, and M6 perform the same functions as the manifolds M1, M2, M5, and M6 according to the above-described embodiment, respectively.

The enclosure 70 is configured as a clamping member for clamping a plurality of unit cells in the first direction together with the end plates 20A and 20B. That is, the clamping pressure of a cell stack including the plurality of unit cells may be maintained by the end plates 20A and 20B including a rigid body structure and the enclosure 70.

The enclosure 70 may include two portions, that is, an inverted L-shaped portion and an L-shaped portion. In the instant case, when the two portions of the enclosure 70 and each of the first and second end plates 20A and 20B are coupled to each other, meeting points at which three portions, i.e., the two portions of the enclosure 70 and the first or second end plate 20A or 20B, meet each other are present so that the two portions of the enclosure 70 and the first or second end plate 20A or 20B are fastened to each other. However, watertightness may not be ensured at these meeting points. Furthermore, there are many bolt-fastening points, which may complicate post-processing of the cell stack.

Hereinafter, methods of manufacturing the other comparative example 10B and the fuel cell 100, 100A, 100B, or 100C according to the exemplary embodiment of the present disclosure will be described.

In both the case of the other comparative example 10B and the case of the exemplary embodiment of the present disclosure, a plurality of unit cells is sequentially stacked on one of the first and second end plates, the other of the first and second end plates is placed on the last unit cell among the plurality of stacked unit cells, and then appropriate load is applied to press the plurality of stacked unit cells.

Thereafter, in the case of the other comparative example 10B, a cell stack is conveyed, with a jig fastened thereto, and then the jig is released from the cell stack. Therefore, the cell stack is inserted into the enclosure 70 and is pressed, and then the end plates 20A and 20B disposed on the respective end portions of the cell stack and the enclosure 70 are fastened to each other.

In contrast, in the case of the exemplary embodiment of the present disclosure, the clamping members 130 are fastened to the first and second end plates 110A and 110B disposed on the respective end portions of the cell stack and are pressed. Thereafter, the enclosure 140 is disposed to enclose the cell stack 122, and then is coupled to the side cover 150.

As described above, in the case of the other comparative example 10B, the enclosure 70 needs to be coupled to the end plates 20A and 20B before pressing the cell stack. Therefore, in the case in which a defective cell is detected in the cell stack after coupling of the enclosure 70, a disassembly process needs to be performed in a reverse order of the manufacturing process to repair the defective cell. That is, it is necessary to separate the enclosure 70 from the end plates 20A and 20B. Therefore, it is very difficult to perform a repair process.

In contrast, in the case of the exemplary embodiment of the present disclosure, the clamping members 130 are fastened to the end plates 110A and 110B to clamp the cell stack 122 without the help of the enclosure 140. Therefore, it is possible to detect a defective cell before coupling the enclosure 140 to the side member 150. That is, according to the exemplary embodiment of the present disclosure, a process of manufacturing the unit stack module and a process of inserting the unit stack module into the enclosure are separately performed. As a result, it is very easy to perform a process of repairing a defective cell compared to the other comparative example.

In the present way, according to the exemplary embodiment of the present disclosure, because a process of inspecting and detecting a defective cell is separately performed from a process of inserting the cell stack into the enclosure 140 after manufacture of the cell stack, the overall manufacturing and inspection processes may be simplified.

Furthermore, in the case of the exemplary embodiment of the present disclosure, even when the second portion P2 of the first clamping member 310 is disposed as shown in FIG. 4, rather than being disposed as shown in FIG. 3B, it is possible to protect the cell stack 122 from external impact and to increase the stability of the cell stack 122 in the event of collision, improving the durability of the cell stack. Because the second portion P2 as the side surface of the first clamping member 310 includes an impact mitigation pattern, it is possible to more reliably ensure the stability of the cell stack in the event of low-speed collision.

Furthermore, in the case of the exemplary embodiment of the present disclosure, after the clamping members 130 are fastened to the end plates 110A and 110B, the sealing washers 170 and 172 are placed around the flange bolts 162, 164, 166, and 168, the enclosure 140 including a “□” shape is placed to enclose the cell stack 122, the side cover 150 is placed to cover the interior of the cell stack 122, and then the third coupling portion 163 is fasted to couple the side cover 150 to the enclosure 140, whereby a completely watertight structure is realized. Accordingly, the watertightness and airtightness performance of the cell stack 122 may be improved, and thus the durability thereof may be improved.

As is apparent from the above description, in the fuel cell according to the exemplary embodiment of the present disclosure, the clamping members may be configured not only to provide clamping pressure to the cell stack but also to protect the cell stack from external impact.

However, the effects achievable through the present disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

Furthermore, for any element or process which is not described in detail in any of the various exemplary embodiments of the present disclosure, reference may be made to the description of an element or a process including the same reference numeral in another exemplary embodiment of the present disclosure, unless otherwise specified.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell, comprising:
a cell stack including a plurality of unit cells stacked in a first direction thereof;
first and second end plates disposed on respective end portions of the cell stack; and
a plurality of clamping members configured to clamp the plurality of unit cells in the first direction, the plurality of clamping members being spaced from each other in a second direction intersecting the first direction,
wherein the plurality of clamping members includes:
a first clamping member disposed on an edge portion of the cell stack to extend in the first direction; and
a second clamping member disposed on at least one of an upper portion or a lower portion of the cell stack to extend in the first direction, wherein the first clamping member includes:
a first portion disposed on or under the cell stack at a position adjacent to the edge portion; and
a second portion bent from the first portion to be disposed on a side portion of the cell stack,
wherein the first portion includes:
a first metal portion; and
a first insulating portion disposed between the first metal portion and the cell stack, and
wherein the second portion includes a second insulating portion disposed on the side portion of the cell stack.

2. The fuel cell of claim 1, wherein the first insulating portion and the second insulating portion are integrally formed with each other. The fuel cell of claim 1, wherein the second clamping member includes:
a second metal portion; and
a third insulating portion disposed between the second metal portion and the cell stack.

4. The fuel cell of claim 1, wherein the second portion covers an entire area of the side portion of the cell stack.

5. The fuel cell of claim 1, wherein the second portion further includes an impact mitigation pattern.

6. The fuel cell of claim 1, wherein the second portion covers a part of the side portion of the cell stack.

7. The fuel cell of claim 6, wherein the second portion is formed so that a thickness thereof in the second direction is reduced in a direction away from the first portion.

8. The fuel cell of claim 1,
wherein the cell stack includes:
an upper surface;
a low surface opposite to the upper surface in a third direction intersecting each of the first direction and the second direction;
a first side surface located between the upper surface and the lower surface; and
a second side surface opposite to the first side surface in the second direction, and
wherein the plurality of clamping members further includes:
a first clamping bar disposed on a boundary at which the upper surface and the first side surface are contiguous with each other;
a second clamping bar disposed on a boundary at which the upper surface and the second side surface are contiguous with each other;
a third clamping bar disposed on a boundary at which the lower surface and the first side surface are contiguous with each other;
a fourth clamping bar disposed on a boundary at which the lower surface and the second side surface are contiguous with each other;
a fifth clamping bar disposed on the upper surface; and
a sixth clamping bar disposed on the lower surface.

9. The fuel cell of claim 8,
wherein each of the first, second, third and fourth clamping bars corresponds to the first clamping member, and
wherein each of the fifth and sixth clamping bars corresponds to the second clamping member.

10. The fuel cell of claim 8,
wherein each of the first and fourth clamping bars corresponds to the first clamping member, and
wherein each of the second, third, fifth, and sixth clamping bars corresponds to the second clamping member.

11. The fuel cell of claim 8,
wherein each of the second and third clamping bars corresponds to the first clamping member, and
wherein each of the first, fourth, fifth and sixth clamping bars corresponds to the second clamping member.

12. The fuel cell of claim 8,
wherein the second insulating portion has an elastic modulus of 12 GPa at 23° C., an impact strength of 10 KJ/m² or greater than 10 KJ/m², and a length of 2 mm to 3 mm in the third direction,
wherein a first end portion of the second insulating portion abutting the first metal portion has a thickness of 15 mm or greater than 15 mm in the second direction, and
wherein a second end portion of the second insulating portion opposite to the first end portion has a thickness of 4 mm or greater 4 mm in the second direction.

13. The fuel cell of claim 9,
wherein the second insulating portion of the first clamping bar and the second insulating portion of the third clamping bar are spaced from each other in the third direction, and
wherein the second insulating portion of the second clamping bar and the second insulating portion of the fourth clamping bar are spaced from each other in the third direction.

14. The fuel cell of claim 9,
wherein the second insulating portion of the first clamping bar and the second insulating portion of the third clamping bar are integrally formed with each other, and
wherein the second insulating portion of the second clamping bar and the second insulating portion of the fourth clamping bar are integrally formed with each other.

15. The fuel cell of claim 1, further including:
a side cover coupled to the second end plate; and
an enclosure coupled to the first end plate and the side cover to enclose the side portion of the cell stack.

16. The fuel cell of claim 15, further including:
a first coupling portion configured to couple the first end plate to a first end portion of each of the clamping members;
a second coupling portion configured to couple the second end plate to a second end portion of each of the clamping members; and
a third coupling portion configured to couple the side cover to the second end plate.

17. The fuel cell of claim 16, wherein at least one of the first, second, and third coupling portions includes:
a flange bolt; and
a sealing washer disposed between the flange bolt and an insertion hole formed to allow the flange bolt to pass therethrough or to be inserted thereinto.

18. The fuel cell of claim 17, wherein the insertion hole includes a diameter of 5 mm or greater than 5 mm and a depth of 9 mm or greater than 9 mm.

19. A fuel cell, comprising:
a cell stack including a plurality of unit cells stacked in a first direction thereof;
first and second end plates disposed on a first end portion and a second end portion of the cell stack, respectively;
a side cover coupled to the second end plate;
an enclosure coupled to the first end plate and the side cover to enclose a side portion of the cell stack;
a first clamping member configured to clamp the plurality of unit cells in the first direction and disposed on an edge portion of the cell stack to extend in the first direction;
a second clamping member configured to clamp the plurality of unit cells in the first direction and disposed on at least one of an upper portion or a lower portion of the cell stack to be spaced from the first clamping member and to extend in the first direction; and
a coupling portion configured to couple each of the first and second clamping members to each of the first and second end plates and to couple the side cover to the enclosure,
wherein the first clamping member includes:
an insulating portion disposed on the edge portion to extend from a region on the upper portion of the cell stack to a region on the side portion of the cell stack; and
a metal portion disposed on a portion of the insulating portion disposed on the upper portion of the cell stack to be coupled to the coupling portion.
